(19) United States
(12) Patent Application Publication
(10) Pub. No.: US 2022/0174875 A1
(43) Pub. Date: Jun. 9, 2022

(54) METHOD AND APPARATUS FOR REMOVING PLANTS OR OTHER MATERIAL EXISTING IN WATER

(71) Applicant: Lännen MCE Oy, Loimaa (FI)

(72) Inventors: Toni MIKKOLA, Loimaa (FI); Jyrki HEINO, Loimaa (FI)

(21) Appl. No.: 17/601,185

(22) PCT Filed: Mar. 30, 2020
(86) PCT No.: PCT/FI2020/050205

§ 371 Date: Oct. 4, 2021

(30) Foreign Application Priority Data
Apr. 5, 2019 (FI) 20190024

(51) Int. Cl. A01D 44/00; A01D 34/73

(52) U.S. Cl. CPC A01D 44/00; A01D 34/73

(57) ABSTRACT

A method for removing plants (6) or other material existing in water by means of a collector head connected to rest on a work machine moving on land and/or in a water system, whereby the collector head is moved in the method in water in the plant layer, and the collected plants (6) are transferred by means of a pump (13) and transfer pipes (3) included in the collector head either onto land or to a cargo area floating on water, such as a barge. By means of at least two feeder drums (14) placed in the collector head and rotatable on their own shafts (11), water plants are shredded and led in the method from between said feeder drums (14) onto a pump (13) located behind said feeder drums, whereby said drums make use of conveyor/shredder members (8) located one over the other at a distance from each other, at least the outermost tips of which are directed forward in the direction of rotation

### BACKGROUND OF THE INVENTION

The present invention relates to a method and apparatus for removing plants or other material existing in water by means of a collector head connected to rest on a work machine moving on land or in a water system, whereby the collector head is moved in the method in water in the plant layer, and the collected plants are transferred, by means of a pump and transfer pipes included in the collector head, onto land or to a cargo area floating on water, such as a barge.

Methods as those described in the above introduction are known in prior art, in which work machines moving in water are used to remove water plants so that at their bow they have a cutter akin to a mowing machine, and behind it a conveyor which transfers the removed plants rearward and at the same time lifts them to the cargo area of the working machine. While moving on the conveyor, most of the water the plants take with them is separated off.

Collecting methods like the ones described in the above are known from e.g publications CN101292588 A and CN203942806 U. These solutions have a cutter blade at the very tip of the apparatus, which means that it cuts the plants on its driving line, only. Consequently, the apparatus cannot pull plants that are outside its driving line to the cutter blade.

### BRIEF DESCRIPTION OF THE INVENTION

The inventive method and apparatus achieve a substantial improvement over the previous methods as the work machine is able to operate continuously in an area because the removal of water plants, for example, onto land takes place continuously by means of a pump. The method and apparatus according to the invention are characterized by what is stated in the independent claims. Preferred embodiments of the invention are disclosed in the dependent claims.

The benefit of the solution put forth is that the structure of the collector head and in particular of its feeder drum structure is such that the collector head may be moved in any direction supported by a boom system, for example, so the feeder drums always collect plants from the water surface and also under the surface, and lead them to the pump. When the cut/crushed water plants or other material are led onto land either by pumping along a pipe or mixed in a water jet sprayed in an arc onto land, working in a water system may be continuous and therefore efficient.

Fixing the feeder drums by means of joints to the body of the collector head allows turning them away from the front of the pump, making it possible to remove, for example, blockages from the apparatus and also to check the condition of the pump.

The disclosed solution is particularly efficient for removing floating water plants. When the feeder drums are rotating, they capture by means of hook-tipped members such as vanes or bars protruding from their surface, plants from also the outer edges of the collector head as well as from the front of the apparatus, pulling intertwined water plants as a floating mat towards the feeder drums. This means that the work machine may even be stationary in the water system, if the plant mass that is to be collected is floating.

### BRIEF DESCRIPTION OF THE DRAWINGS

The invention is now described in closer detail in connection with some embodiments and with reference to the accompanying drawings, in which:

FIG. 1 is a side view of a collector head lowered into a water system;

FIG. 2 shows a horizontal section of a bottom part of collector head; and

FIG. 3 shows the collector head of FIG. 2 with feeder drums turned away from the front of the pump.

### DETAILED DESCRIPTION OF SOME EMBODIMENT OF THE INVENTION

FIG. 1 shows a collector head which is connected to a work machine, e.g. to its boom system, by fastening points 7 and which collects water plants 6 or other material such as litter or waste, and which includes a frame 1, a hydraulic motor 2 driving a pump 13, and a discharge pipe 3 leading water plants or other material away from the pump 13. The collector head further includes at least two feeder drums 14 which are connected to said frame 1 by means of a separate fastening frame 4 for the feeder drums 14. The feeder drums 14 are fixed with bearings to their fastening frame 4 to rotate around shafts 11. A plurality of conveyor/shredder members 8 are fixed to the shaft 11 of the feeder drums 14, which, when rotating, grab water plants 6 and move them to a suction opening 12 of the pump 13.

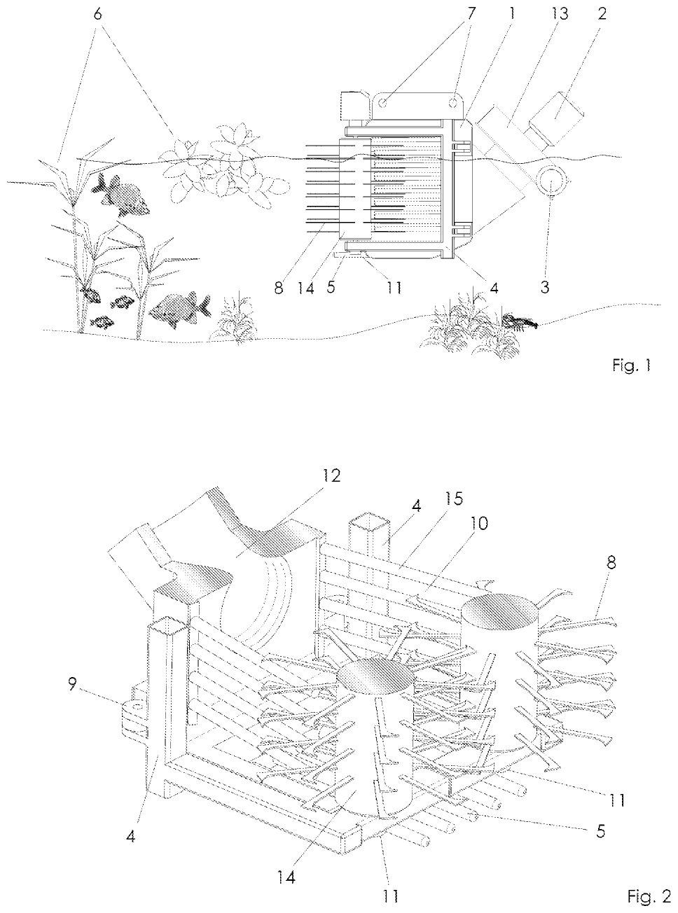

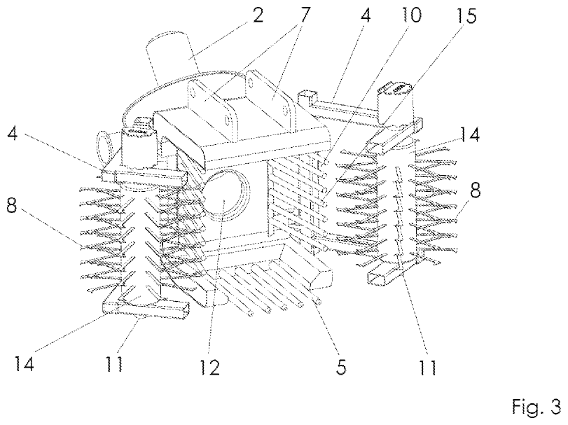

The conveyor/shredder members 8 may be vanes, bars, or disc-like members, for example. At least the outermost tips of the conveyor/shredder members 8 are directed forward in the direction of rotation. As concerns a bar-like conveyor/shredder member 8, this means that an end of the bar has a part extending forward in the direction of rotation from the axial direction of the bar, as shown in FIGS. 2 and 3, for example. In connection with a disc-like member, the outer edge of the discs are provided with a toothing by means of relatively large teeth. The cutting edge of the teeth is directed forward in the direction of rotation, and the outer edge of the teeth extends forward in the direction of rotation. When the outermost tips of the conveyor/shredder member 8 are directed forward in the direction of rotation, the outer edge of the conveyor/shredder member 8 meets a plant or other material before at least point thereof facing the shaft 11 from its outer edge. The fact that at least the outermost tips of the conveyor/shredder member 8 are directed forward in the direction of rotation may also be described so that the structure of the conveyor/shredder member 8 is hook-like. Further, the structure may be described so that at least the outermost portions of the conveyor/shredder member 8, which transfer plants, face forward in the direction of rotation. When at least the outermost tips of the conveyor/shredder member 8 are directed forwards in the direction of rotation, the conveyor/shredder members 8 efficiently collect plants from their range to between the feeder drums 14 and are able to move them towards the pump 13.

Most suitably, there are two feeder drums 14 in parallel, with their shafts 11 vertically to reach the best results. The feeder drums 14 are closely adjacent so that the conveyor/shredder members 8 partly overlap with the corresponding members 8 of the adjacent feeder drum 14. The collector head may be used to collect, for example, water plants fixed to the bottom from different heights as well as floating plants which may grow up from the water surface. To guarantee efficient operation, it is advantageous that the height of the rotating portion of the feeder drums 14 is not less than that of the plants. According to an example, the height of the feeder drums 14 is at least 80 cm.

The feeder drums 14 are the most advantageously rotated around the vertical shaft 11, but other axial directions, too, may be used. The bottom part of the collector head has base structures 5 that first make contact with the bottom and support the collector head when it in certain situations has to be lowered to the bottom to support the position or move of the work machine in a water system.

FIG. 2 shows a collector head by way of example, in which the top part has been cut off as a horizontal section. There are two feeder drums 14 supported by vertical shafts 11. In this case, the conveyor/shredder members 8 are bars that start from the shaft 11, of which there is a plurality of bar sets at their own height positions one over the other, whereby when they are rotating along with the shaft 11 they form disc-like paths at different heights. The conveyor/shredder members 8 of adjacent feeder drums 14, such as discs, vanes, or bars, are at mutually different heights so that they can rotate partly overlapping with adjacent similar ones without hitting each other.

In addition, as shown in FIG. 2, there are guide members 15 at the edges of a path leading from the feeder drums 14 to the suction opening 12 of the pump, the guide members forming gaps 10 at the same height as where the conveyor/shredder members 8 are rotating. The guide members 15 forming the gaps 10 in this solution act as counterparts and counter blades when the conveyor/shredder members 8, while rotating, guide water plants 6, for example, against the members forming the gaps 10. At this point, the water plants 6 are cut and guided to the suction opening 12 of the pump 13. The guide members 15 thus act as counter blades whereby the guide members 15 together with the conveyor/shredder members 8 cut water plants 6 or other material into pieces. Further, the guide members 15 stop water plants 6 or other material from moving with the conveyor/shredder members 8 and lead them into the range of the suction opening 12 of the pump 13. This way, entanglement of water plants or other material around the feeder drums 14 is prevented. The guide members 15 may be, for example, rods or bars as shown in the drawings, or the guide members 15 may be plate-like members, for example. The width of the guide members 15 may be larger than the gaps 10 in between them, whereby water plants 6, for example, are stopped and cut efficiently.

The outermost tips of the conveyor/shredder members 8 are directed forward in the directed of rotation. With this characteristic, the conveyor/shredder members 8 efficiently collect water plants that are within their range to between the feeder drums 14. At the same time, also water flows to the suction opening 12, which is a matter that helps the mass of water plants or other material move to the suction opening 12.

FIG. 2 shows lower fastening points 9 of the frames 4 of the feeder drums 14, whereby they and the similar upper fastening points allow the frames 4 to turn to the side so that the suction opening 12 of the pump 13 is revealed. If blockages occur in the feeder drums 14 or in a pipeline of the pump, this measure may help in clearing the blockages.

FIG. 3 shows the collector head of FIG. 2 opened, that is, the feeder drums 14 turned to the side. In such a case, the suction opening of the pump 13 is visible and the feeder drums 14 are better accessible, making it easier to remove water plants or other material possibly entangled around them.

Those skilled in the art will find it obvious that, as technology advances, the basic idea of the invention may be implemented in many different ways. The invention and its embodiments are thus not restricted to the examples described above but may vary within the scope of the claims.

1. A method for removing plants or other material existing in water by means of a collector head connected to rest on a work machine moving on land and/or in a water system, whereby the collector head is moved in the method in water in the plant layer, and the collected plants are transferred, by means of a pump and transfer pipes included in the collector head, onto land or to a cargo area floating on water, such as a barge, and by means of at least two rotatable feeder drums placed in the collector head on their own shafts plants or other material are shredded and led from between said feeder drums onto the pump located behind said feeder drums, whereby said feeder drums make use of conveyor/shredder members located one over the other at a distance from each other and protruding from the surface of the drum, wherein the outermost tips of at least some of the conveyor/shredder members are directed forward in the direction of rotation, and the passing to the pump of the plant mass or other material directed from between the feeder drums rearward to the pump is ensured by means of guide members formed as counter blades and guiding the flow, whereby by means of gaps located at the division of the conveyor/shredder members and adapted in said guide means, said guide members provide counter blades for the conveyor/shredder means, and entanglement of plants or other material around the feeder drums is prevented.

2. A method as claimed in claim 1, comprising providing a bottom part of said collector head with a base by means of which the work machine is supported to the bottom of a water system, if so required.

3. A method as claimed in claim 1, wherein in the method the feeder drums are fixed to a frame by a pivot mounting so that said feeder drums can be turned away from the front of the pump.

4. A method as claimed in claim 1, wherein the conveyor/shredder members included in the feeder drums are positioned at least partially overlapping in relation to each other.

5. A method as claimed in claim 1, wherein the feeder drums are positioned to rotate around their vertical shafts.

6. An apparatus for removing plants or other material existing in water by means of a collector head connected to rest on a work machine moving on land and/or in a water system, whereby the apparatus includes a collector head which is movable in water in the plant layer, and the collected plants or other material are transferrable by means of a pump and transfer pipes included in the collector head, either onto land or to a cargo area floating on water, such as a barge, and the apparatus further including at least two feeder drums placed in the collector head and rotatable on their own shafts, with which plants or other material may be shredded and led from between said feeder drums onto the pump located behind said feeder drums, whereby said feeder drums have conveyor/shredder members located one over the other at a distance from each other and protruding from the surface of the drum, wherein at least the outermost tips of at least some of the conveyor/shredder members are directed forward in the direction of rotation, and in that the passing of said plants or other material to the pump is ensured by means of guide members formed as counter blades and guiding the flow, whereby gaps are adapted between said guide members, located at the division of the conveyor/shredder members, which guide members and gaps can provide counter blades for the conveyor/shredder means, and entanglement of plants or other material around the drums is preventable.

7. An apparatus as claimed in claim 6, wherein the rotating shafts of the feeder drums are vertical.

8. An apparatus as claimed in claim 6, wherein the height of the feeder drums is at least 80 cm.

9. An apparatus as claimed in claim 6, wherein the bottom part of the collector head is provided with a base by means of which a work machine is supported to the bottom of a water system, if so required.

10. An apparatus as claimed in claim 6, wherein the collector head has a frame, and the feeder drums are fixed to the frame by a pivot mounting so that it is possible to turn said feeder drums away from the front of the pump.

11. An apparatus as claimed in claim 6, wherein the conveyor/shredder members are positioned at least partially overlapping in relation to each other.
